(19) United States
(12) Patent Application Publication
(10) Pub. No.: US 2006/0046708 A1
(43) Pub. Date: Mar. 2, 2006

(54) Device and method for controlling an authentication in a telecommunications network

(76) Inventor: Thomas Ahrndt, Ottobrunn (DE)

Correspondence Address: Siemens Corporation;Intellectual Property Department, 170 Wood Avenue South, Iselin, NJ, 08830, US

(21) Appl. No.: 10/530,740

(22) PCT Filed: Oct. 2, 2003
(86) PCT No.: PCT/DE03/03285

§ 371 Date: Oct. 13, 2005

(30) Foreign Application Priority Data
Oct. 9, 2002 (DE) 102 47 139.8

(51) Int. Cl. H04Q 7/20

(52) U.S. Cl. 455/422.1

(57) ABSTRACT

The invention relates to a device and a method for controlling an authentication in a telecommunications network, using a subscriber connection device for connecting a user region to an exchange by means of an external data transmission interface and for implementing an internal data transmission interface in the user region, the external data transmission interface comprising at least one authentication channel. A control unit is used to monitor switched data traffic on the external and/or internal data transmission interface and controls respective logon/logoff processes in the authentication channel to an internet service provider, according to the monitored switched data traffic.

### CROSS REFERENCE TO RELATED APPLICATIONS

This application is the US National Stage of International Application No. PCT/DE03/03285, filed Oct. 2, 2003 and claims the benefit thereof. The International Application claims the benefits of German application No. 10247139.8 DE filed Oct. 9, 2002, both of the applications are incorporated by reference herein in their entirety.

### FIELD OF INVENTION

The invention relates to a device and a method for controlling an authentication in a telecommunications network, in particularly to a device and a method for automatic logon/logoff to an internet service provider via an xDSL modem.

### BACKGROUND OF INVENTION

With a conventional telecommunications network, a customer premises equipment (CPE) is normally connected via a telephone terminal device to a public or private telephone network and to an exchange located within same. In this way, a voice and/or data link to a further customer premises equipment and a telecommunication terminal located within it can be established via this exchange or a number of additional exchanges. Furthermore, not only can other customer premises equipment be connected by means of exchanges of this kind, but increasingly also Internet service providers (ISP), such as are found on the Internet, can also be connected.

In the Siemens Switching System EWSD (Electronic Digital Switching System) a number of data transmission procedures, such as an analog data transmission using the traditional analog telephone service POTS (Plain Old Telephone Service), in accordance with ISDN (Integrated Services Digital Network) and also with the xDSL standard (Digital Subscriber Line) can be carried out via Line Cards (LC). The telephone terminal devices used in the customer premises equipment are usually in the form of plug-in cards such as PCI-NIC or external equipment with a USB (Universal Serial Bus) or 10-T interface.

Particularly with a connection setup between a customer premises equipment and an Internet service provider (ISP) such as is realized when surfing the Internet or sending an e-mail, an authentication that enables charging according to the service and prevents unauthorized access to the network, is required in addition to setting up a physical data transmission interface or physical data transmission channel.

An authentication in this case means a logon/logoff procedure that determines and checks both the authenticity and the origin of the transmission of information. An identification or identifier and an additional password are basically used for this purpose.

Up to now the authentication, and thus also the start of charging, begins with the connection setup between the subscriber terminal device of a customer premises equipment and the exchange or Internet service provider (ISP) connected to it. Checking the subscriber terminal device for the user was thus less convenient, and this also resulted in higher charges even if a corresponding Internet service was not used.

### SUMMARY OF INVENTION

The object of the invention is therefore to provide a device and a method for controlling an authentication in a telecommunications network, that results in an improved usability and reduction in costs.

In accordance with the invention, this object, with regard to the device and method, is achieved by the features of independent claims.

In particular by the use of a control unit to monitor data traffic on the external data transmission interface and/or of one for data traffic on the internal data transmission interface meant for the external data transmission interface, and for controlling logon/logoff procedures in an authentication channel of the external data transmission interface depending on the monitored data traffic, a connection to the Internet service provider is automatically established or an authentication performed, provided data to be transmitted or received is present in the customer premises equipment, whereas if there are faults in such data a connection to the Internet service provider is automatically discontinued. Usability is thus substantially simplified, whereby, in particular, the costs can be reduced to the actual charges necessary.

Advantageously, the control unit monitors the data traffic in a predetermined time window, whereby connection setups or cleardowns that occur too frequently are prevented via the authentication channel or authentication protocol, thus resulting in an effective time saving.

Preferably, downstream data traffic is monitored on the external data transmission interface and/or upstream data traffic is monitored on the internal data transmission interface, which means that a connection setup or cleardown can be further optimized with regard to time delays.

Preferably, a physical data transmission channel of the external data transmission interface can always be activated independent of the control unit, such as for example is realized in xDSL modems, whereby this physical data transmission channel can be controlled, i.e. a setup or cleardown performed, depending on the data traffic.

### BRIEF DESCRIPTION OF THE DRAWINGS

Further advantageous embodiments of the invention are given in the further claims. The invention is explained in more detail in the following using exemplary embodiments and with reference to drawings.

These are as follows:

FIG. 1 A simplified block diagram of a telecommunications network with a device for controlling authentication in accordance with a first exemplary embodiment; and

FIG. 2 A simplified block diagram of a telecommunications network with a device for controlling an authentication in accordance with a second exemplary embodiment.

### DETAILED DESCRIPTION OF INVENTION

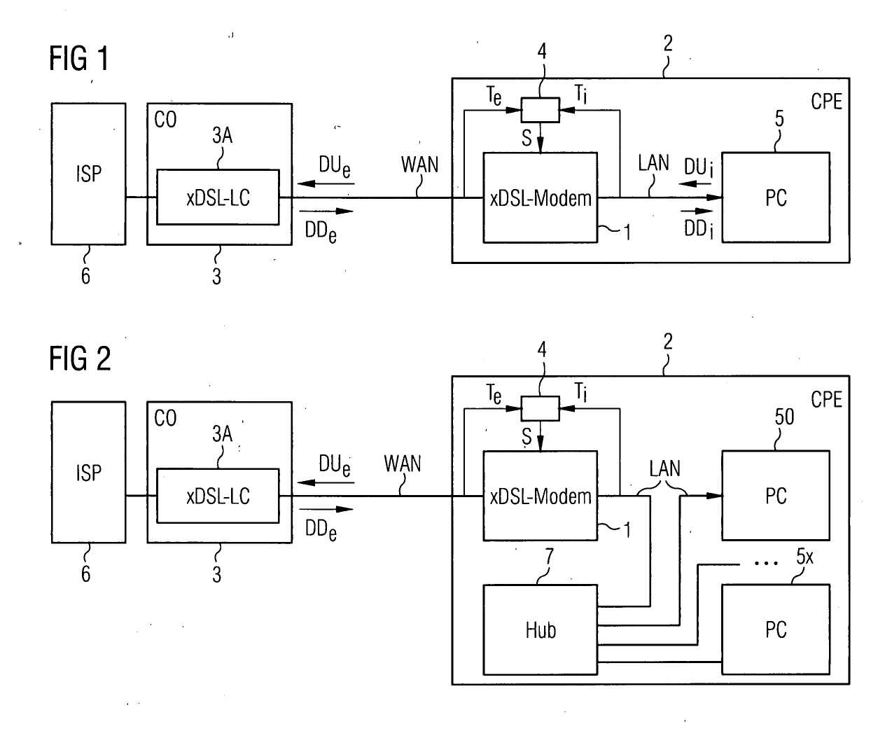

FIG. 1 shows a simplified block diagram of a telecommunications network with a device for controlling an authentication in accordance with a first exemplary embodiment.

In accordance with FIG. 1, a customer premises equipment 2 (CPE) has a subscriber terminal device 1 that is connected via an internal data transmission interface LAN (local area network) with a data processing unit 5 (personal computer PC). With the preferred exemplary embodiment shown in FIG. 1, the subscriber terminal device 1 is an xDSL modem (x digital subscriber line) as is known for realizing data transmissions with a higher bandwidth on conventional ISDN lines. Accordingly, the subscriber terminal device 1 realizes an external data transmission interface WAN (wide area network CO) in the direction of an exchange 3 (central office, CO), that in addition to a physical data transmission layer or the physical DSL data transmission channel (layer 1) also has an authentication channel in a higher layer (layer 1+n) of the ISO layer model.

In the authentication channel, that essentially serves for the transmission of information that specifies an authenticity and an origin of the information, authentication protocols such as the point-to-point protocol (PPC) or the point-to-point protocol over Ethernet (PPPoE) are used for authentication. This means that a logon or logoff at an Internet service provider (ISP) 6 that is also switched to the exchange 3 can thus be carried out.

To realize a terminal device at the exchange end, the exchange or switching system 3 has a line card 3A for this subscriber terminal and, preferably, an xDSL Line Card (sDSL-LC) for connecting the customer premises area 2 via an ISDN two-wire line.

The data streams transmitted on the external data transmission interface WAN are normally designated as upstream data or upstream data traffic DUe (data upstream external) in an upstream direction or towards the exchange 3 and as downstream data or downstream data traffic DDe (data downstream external) in the direction of the customer premises equipment 2. Similarly, the designators DUi (data upstream internal) and DDi (data downstream internal) designate particular upstream or downstream data on the internal data transmission interface LAN.

For automatic control of the logon/logoff procedures in the authentication channel, a control unit 4 is at this point used in the customer premises equipment 2, that on one hand monitors the data traffic Te (traffic external) on the external data transmission interface WAN and/or data traffic Ti (traffic internal) on the internal data transmission interface LAN meant for the external data transmission interface WAN. To be more exact, this means that the amount of ATM (asynchronous transfer mode) cells on the external data transmission interface WAN or of IP packets (Internet protocol) on the internal data transmission interface LAN can be monitored, whereby particularly where an xDSL modem is used as the subscriber terminal device 1, this kind of monitoring is particularly easy to realize.

By using this data corresponding to the monitored data traffic Te and Ti on the external and internal data transmission interfaces, control of the subscriber terminal device 1 by a control signal S is achieved, whereby, in particular, the logon/logoff procedures in the authentication channel can be influenced.

More exactly, the connection to the Internet service provider 6 in the authentication channel is automatically disconnected or interrupted if no data traffic takes place from the external to the internal or from the internal data transmission interface LAN to the external data transmission interface WAN. On the other hand, a connection to the Internet service provider 6 is automatically restored via the authentication channel or the authentication protocols PPP or PPPoP, if data traffic takes place from the internal data transmission interface LAN to the external data transmission interface WAN.

Although at present with xDSL modems it is not possible to activate the external data transmission interface WAN from the exchange end, such an activation is in principle conceivable, and therefore also data traffic from the external data transmission interface WAN to the internal data transmission interface LAN can be monitored for the connection setup in the authentication channel. To adapt the particular reaction times of particular Internet service providers 6 and to avoid unnecessary logon/logoff operations in the authentication channel, the monitoring of the data traffic on the internal and/or external data transmission interface LAN and/or WAN can advantageously be carried out in a predetermined time window. In this case, the data traffic Te and/or Ti is monitored on both interfaces WAN and LAN for a predetermined time period, whereby a logoff procedure is automatically carried out in the authentication channel if no data traffic or no data is detected within the predetermined time period.

Furthermore, the control unit 4 can, for example, monitor only the downstream data traffic DDe on the external data transmission interface WAN and/or the upstream data traffic DUi on the internal data transmission interface LAN, because these data streams are in any case forwarded through the subscriber terminal device 1 in the downstream direction or upstream direction and thus a shortening of the reaction times for the logon/logoff procedure in the authentication channel is enabled.

Data transmission according to the ITU G.992.1 (G,DMT) or ITU G.992.2 (G.Lite) is preferably carried out on the external data transmission interface, with the internal interface LAN being operated using the RFC 1483 (Ethernet over AAL5) or RFC 1577 (IP over AAL5) protocols. With data transmission standards of protocols of this kind, it is particularly easy to implement the aforementioned control of the authentication channel.

As shown in FIG. 1, in the customer premises equipment 2 a data processing unit 5 is switched via an external modem 1 to the exchange 3. In the same way, however, subscriber terminal devices in the form of plug-in cards such as PCI-NIC can also be used for other terminals. Similarly, external modem devices or subscriber terminal devices with, for example, a USB or 10B-T interface can also be used in the customer premises equipment.

With regard to the layer 1 connection setup or the connection setup of a physical data transmission layer or of the physical data transmission channel, such as is realized as a DSL layer by an xDSL modem, it can be seen that this data transmission channel of the external data transmission layer WAN is normally always active i.e. it can in accordance with the invention basically always transmit data to the exchange 3, regardless of the control unit 4.

In principle, however, subscriber terminal devices are also conceivable that have no permanently active transmission state of this kind and accordingly are also controlled relative to the monitored data traffic Ti and/or Te of the internal and/or external data transmission interface LAN and WAN. The costs for the network operator can also be reduced in this way, but this would, however, result in increased delay times because of the physical connection setup and cleardown.

FIG. 2 shows a simplified section view of a telecommunications network with a device for controlling an authentication in accordance with a second exemplary embodiment, with the same reference characters being used to designate the same or corresponding elements and description repetition thus being omitted.

In accordance with FIG. 2, the customer premises equipment 2 can also have a number of data processing units 50 to 5X (personal computers PC) as terminals, that are connected to each other via a connection unit 7 and the internal data transmission interface LAN and to the subscriber terminal 1. The connecting unit 7 in this case can be a “hub” or similarly can also be a “switch”, with different configurations being realizable within the customer premises equipment 2.

This enables not only individuals but also a number of users to access an Internet service provider 6 via a single subscriber terminal device 1, in a particularly simple and inexpensive manner.

The invention has been described in the foregoing using a wired xDSL modem as a subscriber terminal device and a WAN data transmission interface and a LAN data transmission interface for the external and internal data communication. It is, however, not limited to this and in a similar manner can include cordless or wireless applications in which both the internal transmission data interface and also an external data transmission interface are at least partially realized via a radio interface. The types of line cards of connection interfaces 3A shown in FIGS. 1 and 2 are in this case replaced by corresponding radio terminals.

Similarly, the public switching shown can also be realized by private switching, with it being possible for the private exchange to be switched at the exchange end to a public exchange.

1-15. (canceled)

16. A device for controlling an authentication in a telecommunications device, comprising:
a subscriber terminal device in a customer premises equipment;
a connection connecting the subscriber terminal device to an exchange via an external data transmission interface having a physical data transmission channel and an authentication channel;
an internal data transmission interface operatively connected to the customer premises equipment; and
a control unit for monitoring data traffic and for controlling logon and logoff procedures in the authentication channel based on the monitored data traffic, the data traffic selected from the group consisting of traffic on the external data transmission interface, upstream traffic on the internal data transmission interface, and combinations thereof.

17. The device according to claim 16, wherein the control unit monitors the data traffic for a duration of time.

18. The device according to claim 17, wherein the logoff procedure is carried out in the authentication channel if data or the data traffic is not detected within the duration of time.

19. The device according to claim 16, wherein the data traffic on the external data transmission is montitored in a downstream direction.

20. The device according to claim 16, wherein the subscriber terminal device includes an xDSL modem.

21. The device according to claim 16, wherein the external data transmission interface is embodied in accordance with the ITU G.992.1 standard.

22. The device according to claim 16, wherein the external data transmission interface is embodied in accordance with the ITU G.992.2 standard.

23. The device according to claim 16, wherein the authentication channel has an authentication protocol embodied in accordance with a point-to-point protocol.

24. The device according to claim 16, wherein the authentication channel has an authentication protocol embodied in accordance with a point-to-point over Ethernet protocol.

25. The device according to claim 16, wherein the internal data transmission interface is connected to a data processing unit in the customer premises equipment.

26. The device according to claim 16, wherein the control unit controls the physical data transmission channel based on the monitored data traffic.

27. The device according to claim 16, wherein the data transmission channel of the external data transmission interface is active.

28. The device according to claim 16, wherein internal data transmission interface is within the customer premises equipment.

29. A method for controlling an authentication in a telecommunications network, comprising:
providing an external data transmission interface having a physical data transmission channel and an authentication channel;
monitoring a data traffic selected from the group comprising of data on the external data transmission interface, downstream data on an internal data transmission interface, and combinations thereof, and
controlling logon/logoff procedures in the authentication channel based on the monitored data traffic.

30. The method according to claim 29, wherein the data traffic is monitored for a specified duration of time.

31. The method according to claim 29, wherein a downstream of the external data transmission interface is monitored.

32. The method according to claim 29, wherein the subscriber terminal device includes an xDSL modem and the external data transmission interface transmits data embodied in accordance with the ITU G.992.1 standard or the ITU G.992.2 standard.

33. The method according to claim 29, further comprising controlling the physical data transmission channel of the external data transmission interface based on the monitored data traffic.

34. The method according to claim 29, where in the data transmission is active.
